(19) United States
(12) Patent Application Publication
(10) Pub. No.: US 2022/0289025 A1
(43) Pub. Date: Sep. 15, 2022

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventors: Misa Komuro, Wako-shi (JP); Yosuke Sakamoto, Wako-shi (JP)

(21) Appl. No.: 17/680,343

(22) Filed: Feb. 25, 2022

(30) Foreign Application Priority Data
Mar. 11, 2021 (JP) 2021-038903

(51) Int. Cl. B60K 31/00; B60W 30/09

(52) U.S. Cl. CPC B60K 31/0008; B60W 30/09; B60W 2720/106; B60W 2554/4029; B60W 2554/802

(57) ABSTRACT

A control device for a mobile object includes a recognizer capable of recognizing a situation in a periphery of a mobile object, and a controller configured to control acceleration or deceleration of the mobile object based on the recognized situation in the periphery, and, when (1) there is a first obstacle that makes it difficult to recognize a situation on an opposite side in recognition of the situation in an extending direction of a road, (2) an end of the first obstacle is recognized and the first obstacle extends a first predetermined distance forward from the end, and (3) there is no second obstacle that makes it difficult to recognize the situation on the opposite side over a second predetermined distance on a traveling direction side of the mobile object from the end, the controller sets a risk area at a reference position based on the end of the first obstacle, and controls at least a speed of the mobile object based on the set risk area.

### CROSS-REFERENCE TO RELATED APPLICATION

Priority is claimed on Japanese Patent Application No. 2021-038903, filed Mar. 11, 2021, the content of which is incorporated herein by reference.

### BACKGROUND

### Field of the Invention

The present invention relates to a control device for a mobile object, a control method for a mobile object, and a storage medium.

### Description of Related Art

Conventionally, a vehicle control device that sets a risk area in consideration of a future behavior of an oncoming vehicle has been disclosed (Japanese Unexamined Patent Application, First Publication No. 2020-185968).

### SUMMARY

However, the technology described above focuses on an oncoming vehicle, and in some cases other situations are not sufficiently considered.

The present invention has been made in consideration of such circumstances, and an object thereof is to provide a control device for a mobile object, a control method for the mobile object, and a storage medium capable of controlling the mobile object more appropriately.

A control device for a mobile object, a control method for the mobile object, and a storage medium according to the present invention have adopted the following configuration.

(1) A control device for a mobile object according to one aspect of the present invention includes a storage device that has stored a program and a hardware processor, in which the hardware processor executes the program stored in the storage device, thereby recognizing a situation in a periphery of a mobile object, executing control processing of controlling acceleration or deceleration of the mobile object based on the recognized situation in the periphery, and, in the control processing, when (1) there is a first obstacle that makes it difficult to recognize a situation on an opposite side in recognition of the situation in an extending direction of a road, (2) an end of the first obstacle is recognized and the first obstacle extends a first predetermined distance forward from the end, and (3) there is no second obstacle that makes it difficult to recognize the situation on the opposite side over a second predetermined distance on a traveling direction side of the mobile object from the end, setting a risk area at a reference position based on the end of the first obstacle, and controlling at least a speed of the mobile object based on the set risk area.

(2): In the aspect of (1) described above, in the control device for a mobile object, the hardware processor causes the mobile object to decelerate as the mobile object approaches the risk area.

(3): In the aspect of (1) described above, the hardware processor increases a size of the set risk area as the mobile object approaches the end of the first obstacle.

(4): In the aspect of (1) described above, the hardware processor increases a size of the set risk area as the mobile object approaches the end of the first obstacle, and causes the mobile object to decelerate as the mobile object approaches the risk area.

(5): In the aspect of (1) described above, the hardware processor determines a size of the risk area based on a recommended speed on a road on which the mobile object is present.

(6): In the aspect of (1) described above, the first predetermined distance is a sufficient length for a person to hide on an opposite side of the first obstacle.

(7): In the aspect of (1) described above, the second predetermined distance is a sufficient length for a person to pass therethrough.

(8): In the aspect of (1) described above, the hardware processor causes the mobile object to decelerate to a first speed when (1), (2), and (3) are satisfied, and controls the mobile object to travel at a speed higher than the first speed without causing the mobile object to decelerate to the first speed when (1), (2), and (3) are satisfied, and there is furthermore a second lane between the first obstacle and a first lane in which the mobile object moves.

(9): A control method for a mobile object according to another aspect of the present invention includes, by a computer, recognizing a situation in a periphery of a mobile object, controlling acceleration or deceleration of the mobile object based on a recognized situation in the periphery, and, when (1) there is a first obstacle that makes it difficult to recognize a situation on an opposite side in recognition of the situation in an extending direction of a road, (2) an end of the first obstacle is recognized and the first obstacle extends a first predetermined distance forward from the end, and (3) there is not second obstacle that makes it difficult to recognize the situation on the opposite side over a second predetermined distance on a traveling direction side of the mobile object from the end, setting a risk area at a reference position based on the end of the first obstacle, and controlling at least a speed of the mobile object based on the set risk area.

(10): A storage medium according to still another aspect of the present invention is a computer-readable non-transitory storage medium that has stored a program causing a computer to execute recognizing a situation in a periphery of a mobile object, controlling acceleration or deceleration of the mobile object based on a recognized situation in the periphery, and, when (1) there is a first obstacle that makes it difficult to recognize a situation on an opposite side in recognition of the situation in an extending direction of a road, (2) an end of the first obstacle is recognized and the first obstacle extends a first predetermined distance forward from the end, and (3) there is no second obstacle that makes it difficult to recognize the situation on the opposite side over a second predetermined distance on a traveling direction side of the mobile object from the end, setting a risk area at a reference position based on the end of the first obstacle, and controlling at least a speed of the mobile object based on the set risk area.

According to (1) to (10), a control device of a mobile object can control the mobile object more appropriately by setting a risk area according to a situation.

According to (2) or (4), a control device of a mobile object can cause the mobile object to decelerate more appropriately according to a situation in the periphery of the mobile object.

According to (8), a control device of a mobile object can suppress an excessive deceleration of the mobile object.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram (part 1) for describing processing of a setting processor.

FIG. 4 is a diagram (part 2) for describing the processing of a setting processor.

FIG. 5 is a diagram (part 3) for describing the processing of a setting processor.

FIG. 6 is a diagram (part 1) which shows an example of a risk area to be set.

FIG. 7 is a diagram which conceptually shows a risk area.

FIG. 8 is a diagram (part 2) which shows an example of a risk area to be set.

FIG. 9 is a diagram (part 1) for describing setting of a risk area.

FIG. 10 is a diagram (part 2) for describing the setting of a risk area.

FIG. 11 is a diagram which shows a situation in which a pedestrian is present on an opposite side of a first obstacle.

FIG. 12 is a diagram (part 1) which shows an example of a situation in which a risk area is not set.

FIG. 13 is a diagram (part 2) which shows an example of the situation in which a risk area is not set.

FIG. 14 is a flowchart which shows an example of a flow of processing executed by an automated driving control device.

### DESCRIPTION OF EMBODIMENTS

In the following description, embodiments of a control device for a mobile object, a control method for a mobile object, and a storage medium of the present invention will be described with reference to the drawings. As used throughout this disclosure, the singular forms “a,” “an,” and “the” include plural reference unless the context clearly dictates otherwise. In the present embodiment, the mobile object is described as a vehicle, but the present invention may be applied to another mobile object different from a vehicle.

[Overall Configuration]

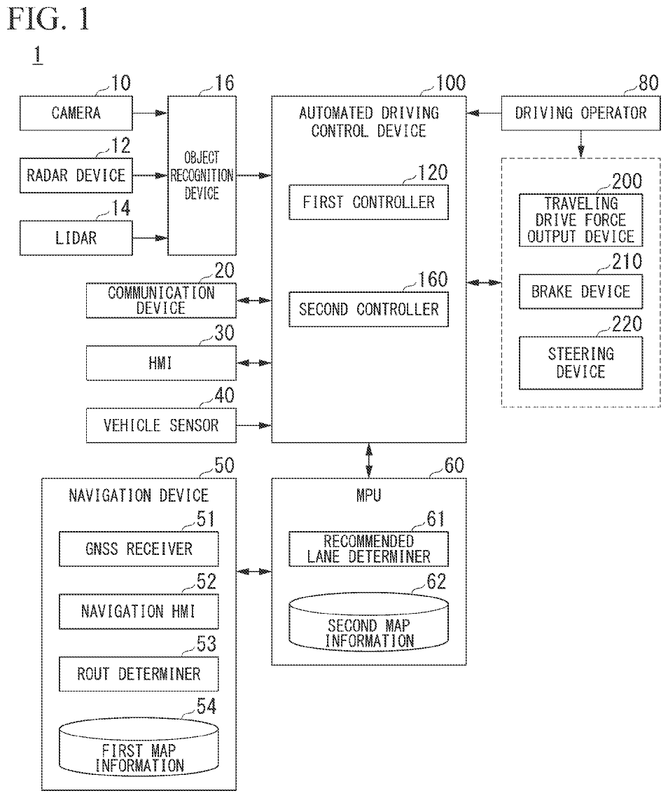

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle system 1 includes, for example, a camera 10, a radar device 12, a light detection and ranging (LIDAR) 14, an object recognition device 16, a communication device 20, a human machine interface (HMI) 30, and a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is a digital camera that uses a solid-state image sensor such as a charge coupled device (CCD) or a complementary metal oxide semiconductor (CMOS). The camera 10 is attached to an arbitrary place in a vehicle (hereinafter, referred to as a host vehicle M) in which the vehicle system 1 is mounted. The camera 10 is attached in, for example, a vehicle compartment. When an image of the front is captured, the camera 10 is attached to an upper part of the front windshield, a back surface of the windshield rear-view mirror, or the like. The camera 10 periodically and repeatedly captures, for example, an image of a periphery of the host vehicle M. The camera 10 may be a stereo camera.

The radar device 12 radiates radio waves such as millimeter waves to the periphery of the host vehicle M, and also detects at least a position (a distance and an orientation) of an object by detecting radio waves (reflected waves) reflected by the object. The radar device 12 is attached to an arbitrary place on the host vehicle M. The radar device 12 may detect the position and speed of an object in a frequency modulated continuous wave (FM-CW) method.

The LIDAR 14 irradiates the periphery of the host vehicle M with light (or an electromagnetic wave having a wavelength close to that of light) and measures scattered light. The LIDAR 14 detects a distance to a target based on a time from light emission to light reception. The irradiated light is, for example, a pulsed laser beam. The LIDAR 14 is attached to an arbitrary place on the host vehicle M.

The object recognition device 16 performs sensor fusion processing on a result of detection performed by some or all of the camera 10, the radar device 12, and the LIDAR 14, and recognizes the position, type, speed, and the like of an object. The object recognition device 16 outputs a result of recognition to the automated driving control device 100. The object recognition device 16 may output the results of detection performed by the camera 10, the radar device 12, and the LIDAR 14 to the automated driving control device 100 as they are. The object recognition device 16 may be omitted from the vehicle system 1.

The communication device 20 communicates with other vehicles present in the periphery of the host vehicle M by using, for example, a cellular network, a Wi-Fi network, Bluetooth (a registered trademark), dedicated short range communication (DSRC), or the like, or communicates with various server devices via a wireless base station.

The HMI 30 presents various types of information to an occupant of the host vehicle M and receives an input operation by the occupant. The HMI 30 includes various display devices, a speaker, a buzzer, a touch panel, a switch, a key and the like.

The vehicle sensor 40 includes a vehicle speed sensor that detects a speed of the host vehicle M, an acceleration sensor that detects acceleration, a yaw rate sensor that detects an angular speed around a vertical axis, an azimuth sensor that detects a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M based on a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the host vehicle M can travel on a reasonable route to proceed to the branch destination.

The second map information 62 is map information with higher accuracy than the first map information 54. The second map information 62 includes, for example, information on a center of a lane, information on a boundary of the lane, and the like. The second map information 62 may include road information, traffic regulation information, address information (addresses/zip codes), facility information, telephone number information, and the like. The second map information 62 may be updated at any time by the communication device 20 communicating with another device.

The driving operator 80 includes, for example, in addition to a steering wheel 82, an accelerator pedal, a brake pedal, a shift lever, and other operators. The driving operator 80 is attached to a sensor that detects the amount of operation or a presence or absence of an operation, and a result of detection is output to the automated driving control device 100, or some or all of the traveling drive force output device 200, the brake device 210, and the steering device 220. An operator does not necessarily have to be annular, and may be in a form of a deformed steer, a joystick, a button, or the like.

The automated driving control device 100 includes, for example, a first controller 120 and a second controller 160. The first controller 120 and the second controller 160 are each realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the automated driving control device 100, or may be stored in a detachable storage medium such as a DVD or a CD-ROM and installed in the HDD or flash memory of the automated driving control device 100 by the storage medium (non-transitory storage medium) being attached to a drive device.

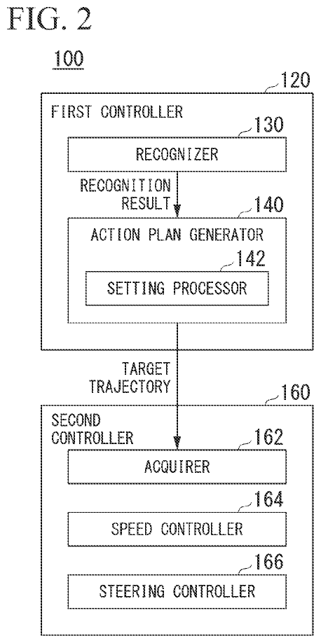

FIG. 2 is a functional configuration diagram of the first controller 120 and the second controller 160. The first controller 120 includes, for example, a recognizer 130 and an action plan generator 140. The first controller 120 realizes, for example, a function of artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating the both. As a result, reliability of automated driving is ensured.

The recognizer 130 recognizes the position, and states such as a speed and acceleration of an object in the periphery of the host vehicle M based on information input from the camera 10, the radar device 12, and the LIDAR 14 via the object recognition device 16. The position of an object is recognized as, for example, a position on absolute coordinates with a representative point (a center of gravity, a center of a drive axis, or the like) of the host vehicle M as an origin, and is used for control. The position of an object may be represented by a representative point such as the center of gravity or a corner of the object, or may be represented by an area. The “states” of an object may include the acceleration or jerk of the object, or a “behavioral state” (for example, whether a lane is being changed or is about to be changed).

The recognizer 130 recognizes, for example, a lane (a traveling lane) in which the host vehicle M is traveling. For example, the recognizer 130 recognizes a traveling lane by comparing a pattern of road lane marking (for example, an array of solid lines and broken lines) obtained from the second map information 62 with a pattern of road lane marking in the periphery of the host vehicle M recognized from an image captured by the camera 10. The recognizer 130 may also recognize a traveling lane by recognizing not only the road lane marking but also road boundaries including the road lane marking, a road shoulder, a curb, a median strip, a guardrail, and the like. In this recognition, the position of the host vehicle M acquired from the navigation device 50 and a result of processing by the INS may be added. The recognizer 130 recognizes stop lines, obstacles, red lights, tollhouses, and other road events.

The recognizer 130 recognizes the position and posture of the host vehicle M with respect to a traveling lane when a traveling lane is recognized. The recognizer 130 may recognize, for example, a deviation of a reference point of the host vehicle M from a center of the lane and an angle of the host vehicle M, formed with respect to a line connecting the centers of the lane in the traveling direction, as a relative position and the posture of the host vehicle M with respect to the traveling lane. Instead, the recognizer 130 may recognize the position or the like of the reference point of the host vehicle M with respect to any side end (a road lane marking or road boundary) of the traveling lane as the relative position of the host vehicle M with respect to the traveling lane.

In principle, the action plan generator 140 travels in a recommended lane determined by the recommended lane determiner 61, and, furthermore, generates a target trajectory on which the host vehicle M automatically (regardless of an operation of a driver) travels in the future so as to be able to respond to surrounding conditions of the host vehicle M. The target trajectory includes, for example, a speed element. For example, the target trajectory is expressed as a sequence of points (trajectory points) to be reached by the host vehicle M. The trajectory point is a point to be reached by the host vehicle M for each predetermined traveling distance (for example, about several [m]) along a road, and, separately, a target speed and a target acceleration for each predetermined sampling time (for example, about decimal point number [sec]) are generated as a part of the target trajectory. The trajectory point may be a position to be reached by the host vehicle M at a corresponding sampling time for each predetermined sampling time. In this case, information on the target speed and target acceleration is expressed by an interval between trajectory points.

The action plan generator 140 may set an event of automated driving when a target trajectory is generated. The event of automated driving includes a constant-speed traveling event, a low-speed following traveling event, a lane change event, a branching event, a merging event, and a takeover event. The action plan generator 140 generates a target trajectory according to an event to be started. The action plan generator 140 includes a setting processor 142 and controls the vehicle M based on a risk area set by the setting processor 142. Details of the risk area and the setting processor 142 will be described below.

The second controller 160 controls the traveling drive force output device 200, the brake device 210, and the steering device 220 so that the host vehicle M passes through a target trajectory generated by the action plan generator 140 at a scheduled time.

The second controller 160 includes, for example, an acquirer 162, a speed controller 164, and a steering controller 166. The acquirer 162 acquires information on a target trajectory (trajectory points) generated by the action plan generator 140 and stores the information in a memory (not shown). The speed controller 164 controls the traveling drive force output device 200 or the brake device 210 based on a speed element associated with the target trajectory stored in the memory. The steering controller 166 controls the steering device 220 according to a degree of bending of the target trajectory stored in the memory. Processing of the speed controller 164 and the steering controller 166 is realized by, for example, a combination of feedforward control and feedback control. As an example, the steering controller 166 executes the combination of feedforward control according to a curvature of a road in front of the host vehicle M and feedback control based on a deviation from the target trajectory.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and an electronic control unit (ECU) that controls these. The ECU controls the configuration described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor according to the information input from the second controller 160 or the information input from the driving operator 80 so that a brake torque according to a braking operation is output to each wheel. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to the information input from the second controller 160 to transmit the hydraulic pressure of the master cylinder to the cylinder.

The steering device 220 includes, for example, a steering ECU and an electric motor. The electric motor changes, for example, a direction of a steering wheel by applying a force to a rack and pinion mechanism. The steering ECU drives the electric motor according to the information input from the second controller 160 or the information input from the driving operator 80, and changes the direction of the steering wheel.

[Processing Executed by Setting Processor]

When (1) there is a first obstacle that makes it difficult to recognize a situation on an opposite side in recognition of the situation executed by the recognizer 130 in an extending direction of a road, (2) an end of the first obstacle is recognized and the first obstacle extends a first predetermined distance forward from the end, and (3) there is no second obstacle that makes it difficult to recognize the situation on the opposite side over a second predetermined distance or more on a traveling direction side of the mobile object from the end, the setting processor 142 sets a risk area at a reference position based on the end of the first obstacle, and controls at least the speed of the mobile object based on the set risk area. In the following description, these types of processing will be described.

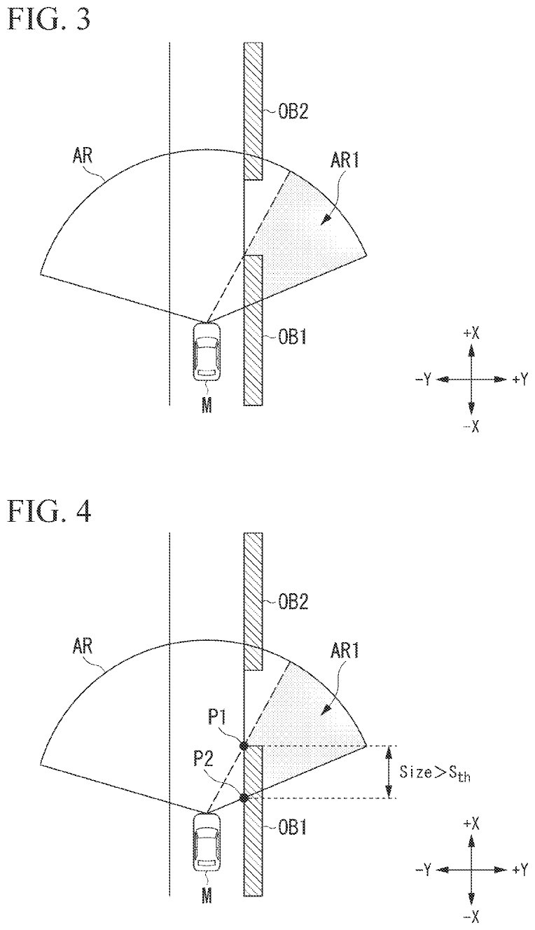

The setting processor 142 determines whether there is a first obstacle that makes it difficult to recognize a situation on an opposite side in the recognition of the situation executed by the recognizer 130 in the extending direction of a road. FIG. 3 is a diagram (part 1) for describing processing of the setting processor 142. In FIG. 3, the vehicle M is traveling on a road. A traveling direction of the vehicle M (the extending direction of the road) is referred to as a positive X direction, a direction opposite to the traveling direction is referred to as a negative X direction, a direction that is orthogonal to the traveling direction and a right direction of the vehicle M is referred to as a positive Y direction, and a direction opposite to the positive Y direction is referred to as a negative Y direction.

A first obstacle OB1 and a second obstacle OB2 are present on the positive Y direction side of the road. The first obstacle OB1 is present in the positive Y direction of the vehicle M and extends in the positive X direction. The second obstacle OB2 is present at a position a predetermined distance apart from the end of the first obstacle OB1, and the second obstacle OB2 extends in the positive X direction.

The recognizer 130 can recognize a situation of an area AR when the first obstacle OB1 and the second obstacle OB2 are not present. However, the first obstacle OB1 makes it difficult (blocks) for the recognizer 130 to recognize an area AR1. The area AR1 is an area on an opposite side (a back side or a distant side) of the first obstacle OB1 when viewed from the vehicle M. In a situation like that shown in FIG. 3, the setting processor 142 determines that there is the first obstacle OB1 that makes it difficult to recognize the situation on the opposite side in the recognition of a situation executed by the recognizer 130 in the extending direction of the road.

FIG. 4 is a diagram (part 2) for describing the processing of the setting processor 142. Description that overlaps that of FIG. 3 will be omitted. The setting processor 142 determines whether an end of the first obstacle OB1 is recognized and the first obstacle OB1 extends the first predetermined distance forward from the end. The setting processor 142 determines, for example, whether a length between a position P1 and a position P2 in the X direction is larger than a threshold value Sₜₕ.

The position P1 is the end of the first obstacle OB1 (an angle in the positive X direction and the negative Y direction), and the position P2 is an outer edge of the area AR and is a position intersecting with the first obstacle OB1 (a position intersecting with the first obstacle OB1 and a position close to the vehicle M). The threshold value Sₜₕ is a sufficient length for a person to hide on an opposite side of the first obstacle OB1, and is, for example, a length of about 1 m. In a situation shown in FIG. 4, it is assumed that the length between the position P1 and the position P2 in the X direction is longer than the threshold value Sₜₕ. The setting processor 142 determines that the end of the first obstacle OB1 is recognized and the first obstacle extends the first predetermined distance forward from the end.

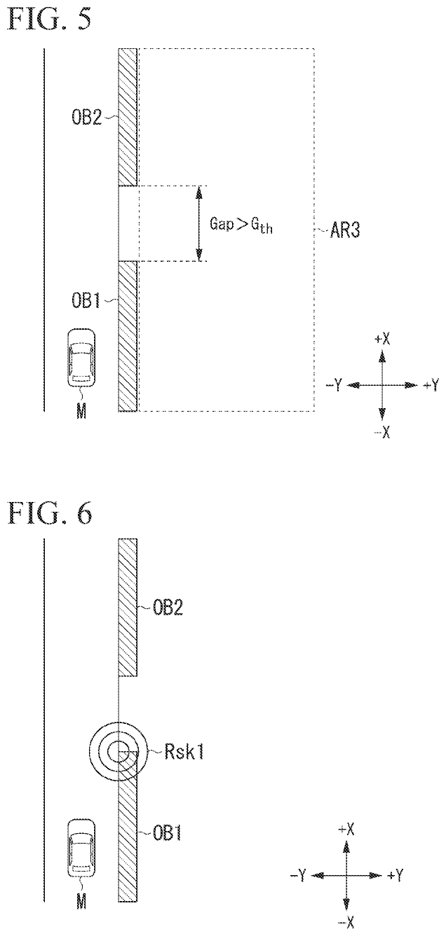

FIG. 5 is a diagram (No. 3) for describing the processing of the setting processor 142. Description that overlaps that of FIG. 3 will be omitted. The setting processor 142 determines whether there is no second obstacle OB2 that makes it difficult to recognize the situation on the opposite side over a second predetermined distance or more on the traveling direction side of the vehicle M from the end of the first obstacle OB1. The setting processor 142 determines whether an interval (Gap) between the end of the first obstacle OB1 and the end of the second obstacle OB2 (the end on the first obstacle OB1 side) is larger than a threshold value Gₜₕ.

The opposite side is an area on the back side or the distant side of the first obstacle OB1 or the second obstacle OB2 with respect to the vehicle M. The opposite side is, for example, an area AR3 in FIG. 5. The second obstacle OB2 is an obstacle that makes it difficult for the recognizer 130 to recognize a situation of the area AR3 on an opposite side of the second obstacle OB.

The threshold value Gₜₕ is a sufficient length for a person to pass therethrough, and is, for example, a length of about 0.5 m. In FIG. 5, it is assumed that Gap is larger than the threshold value Gₜₕ. When Gap is larger than the threshold value Gₜₕ, the setting processor 142 determines that there is a second obstacle that makes it difficult to recognize the situation on the opposite side that satisfies the condition (3) described above.

When the conditions (1), (2), and (3) described above are satisfied, the setting processor 142 sets a risk area Rsk1 at a reference position based on the end of the first obstacle OB1 as shown in FIG. 6. The reference position may be at the end, or may be in a periphery thereof. Then, the action plan generator 140 controls at least the speed of the vehicle M based on the set risk area Rsk1. For example, the action plan generator 140 causes the vehicle M to decelerate.

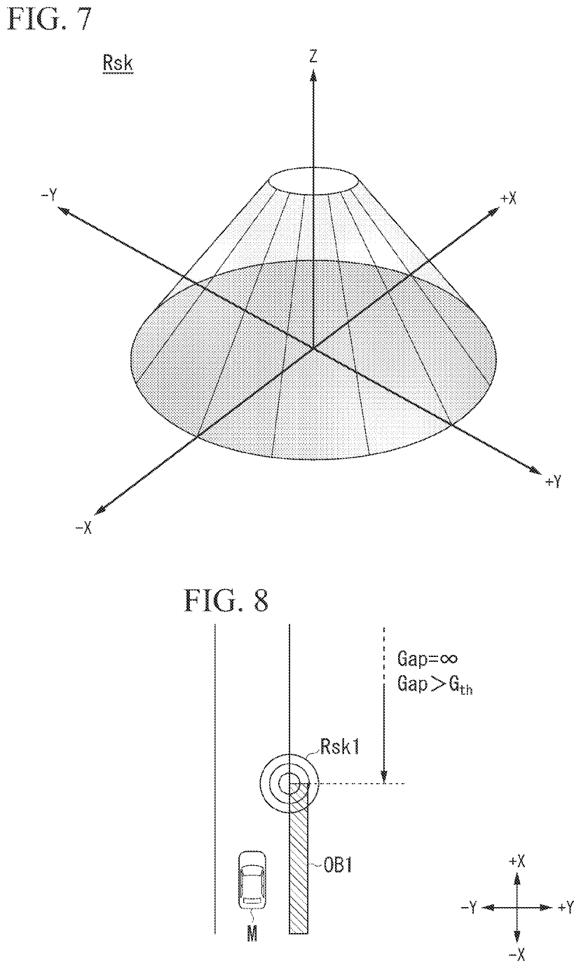

FIG. 7 is a diagram which conceptually shows a risk area Rsk. The “risk area” is an area in which a risk potential is set. The “risk potential” is an index value indicating a degree of a risk when the vehicle M enters the area in which a risk potential is set. The risk area is an area in which a risk potential that is an index value of a predetermined size (an index value exceeding zero) is set. As shown in FIG. 7, a positive Z direction (a direction orthogonal to the X direction and the Y direction) indicates a height of a risk potential. For example, the risk potential is set to be higher as a center of the risk potential (a reference position of a shield OB2) is approached, and the risk potential is set to be lower as the distance from the center of the risk potential increases.

The risk area may be set based on the position of an object. The “object” is an object that may affect traveling of the vehicle M and includes any of various moving objects such as a vehicle, a pedestrian, a two-wheeled vehicle, and an obstacle.

The automated driving control device 100 performs control such that the vehicle M is caused to decelerate (decrease its speed) as the vehicle M approaches a risk area. For example, the automated driving control device 100 decreases the speed of the vehicle M as the vehicle M approaches a position where a risk potential is high (the center of the risk area).

In the example described above, an example in which the second obstacle OB2 is present has been described, but, as shown in FIG. 8, the risk area Rsk1 may be set even when the second obstacle OB2 is not present. In this case, the setting processor 142 considers Gap to be infinite (c) and determines that Gap is larger than the threshold value Gₜₕ. The setting processor 142 determines that there is no second obstacle that makes it difficult to recognize the situation on the opposite side over a second predetermined distance or more on a traveling direction side of the mobile object from the end of the first obstacle OB1, and sets the risk area Rsk1.

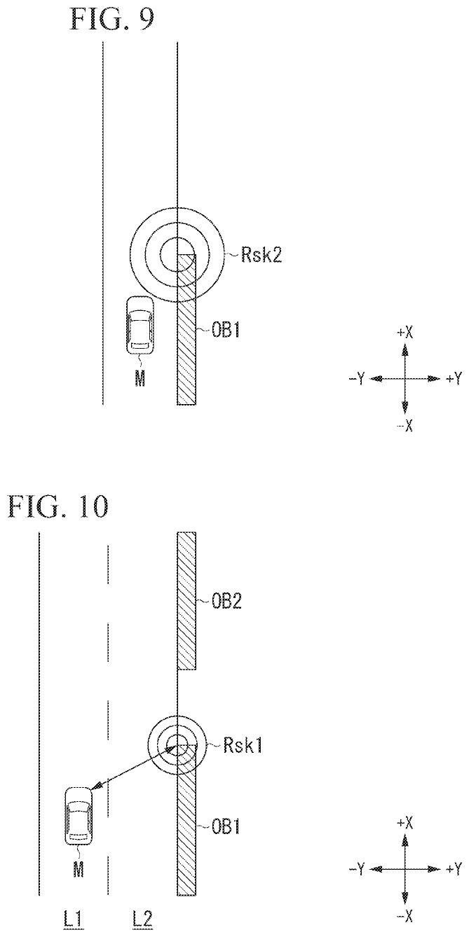

FIG. 9 is a diagram (part 1) for describing setting of a risk area. The setting processor 142 may increase a size of the risk area as the vehicle M approaches the end of the first obstacle OB1. A size of a risk area Rsk2 in FIG. 9 is larger than a size of the risk area Rsk1 described above. For example, the risk area Rsk2 has the center similar to the size of the risk potential of the risk area Rsk1, and has a shape in which the circumference of the bottom surface of the risk area Rsk1 is enlarged. A risk potential between the center and the outer edge of the risk area Rsk1 and the risk area Rsk2 may correspond to, for example, coordinates in a Z direction of a straight line connecting the center and the outer edge, or correspond to coordinates in the Z direction of a straight line connecting the centers and the outer edges in a non-linear manner. The risk potential between the centers and the outer edges of the risk area Rsk1 and the risk area Rsk2 may be in a step shape. In the example of FIG. 9, the vehicle M is located closer to the risk area Rsk2 than in the case of FIG. 8. In this case, the automated driving control device 100 causes the vehicle M to travel at a slower speed than in the situation in FIG. 8.

FIG. 10 is a diagram (part 2) for describing the setting of a risk area. For example, it is assumed that a lane L2 is present between a lane L1 in which the vehicle M travels and the first obstacle OB1. In this case, since the end of the first obstacle OB1 and the vehicle M maintain a predetermined distance therebetween, the risk area Rsk1 (a risk area smaller than the risk area Rsk2) is set at the end of the first obstacle OB1. For example, even if the position of the vehicle M in the traveling direction with respect to the end of the first obstacle OB1 in FIG. 9 is the same as the position of the vehicle M in the traveling direction with respect to the end of the first obstacle OB1 in FIG. 10, since the position in a horizontal direction is far in FIG. 10, the risk area Rsk1 is set instead of the risk area Rsk2. In such a case, the vehicle M is not easily affected by the risk area Rsk1 and can travel smoothly.

A risk area is determined by, for example, a legal speed. For example, as the legal speed increases, the size of a risk area is set to be larger. For example, the size of a risk area may be derived by the following equation (1). “Size_risk” is the size of a risk area, “V_law” is the legal speed, and “thw_p” is a distance from the vehicle M to a predetermined position (for example, the end of the first obstacle OB1). The size of a risk area is derived by, for example, a function using “V_law” and “thw_p.” The function may include something different from what is described above.

Size_risk=f(V_law,thw_p) (1)

The size of a risk area may be derived by the following equation (2). “k1” and “k2” are predetermined coefficients.

Size_risk=f(k1×V_law)×(k2/thw_p) (2)

In the function described above, instead of “V_law,” a speed suitable for passing through the road may be used. “V_law” or a suitable speed is an example of “recommended speed.” In the function described above, instead of “thw_p,” a position other than the first obstacle OB1 may be used. The size of a risk area may be derived based on a table generated to obtain the size of a risk area or a model different from the function described above.

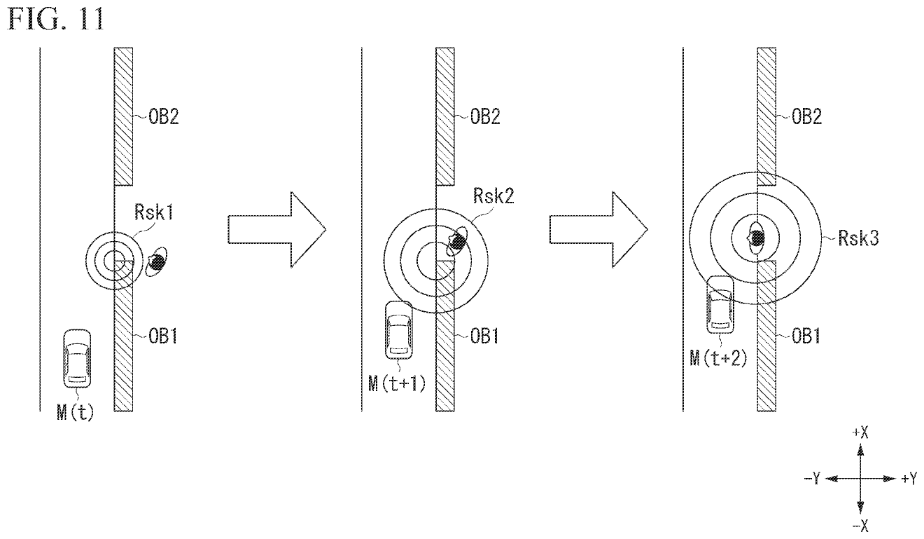

FIG. 11 is a diagram which shows a situation in which a pedestrian is present on the opposite side of the first obstacle OB1. At a time t, a pedestrian is present on the opposite side of the first obstacle OB1, but the recognizer 130 cannot recognize the pedestrian due to the first obstacle OB1. The setting processor 142 sets the risk area Rsk1, and the vehicle M decelerates. At a time t+1, when the vehicle M approaches the end of the first obstacle OB1, the setting processor 142 sets the risk area Rsk2 which is larger than the risk area Rsk1. As a result, the vehicle M decelerates more based on the risk area.

At a time t+3, when the pedestrian approaches a roadway from the opposite side of the first obstacle OB1, the setting processor 142 sets a risk area (omitted in FIG. 11) at the end of the first obstacle OB1 and, furthermore, sets a risk area Rsk3 with respect to the pedestrian. The vehicle M decelerates based on the risk area set at the end of the first obstacle OB1 and the risk area Rsk3. For example, the vehicle M slows down or stops in front of the pedestrian to perform control based on a behavior of the pedestrian.

As described above, the automated driving control device 100 can set an appropriate risk area based on the first obstacle OB1, a pedestrian, and the like, and can appropriately control the vehicle M based on the set risk area.

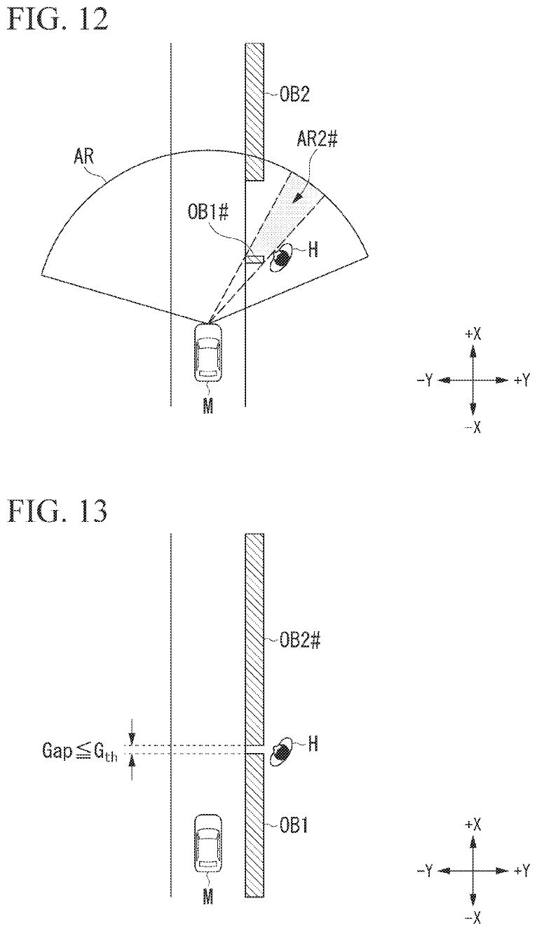

FIG. 12 is a diagram (part 1) which shows an example of a situation in which a risk area is not set. The setting processor 142 does not set a risk area because (1) there is a first obstacle OB1 # that makes it difficult to recognize a situation on an opposite side in the recognition of a situation by the recognizer 130 in the extending direction of a road, but (2) the end of the first obstacle OB1 # is recognized, and the first obstacle OB1 # does not extend forward a first predetermined distance from the end of the first obstacle OB1 #. As shown in FIG. 12, when the first obstacle OB1 # is present, but a length from the end of the first obstacle OB1 # is less than the first predetermined distance, even if an object such as a person H is present on the opposite side of the first obstacle OB1 #, since the recognizer 130 can recognize the object present on the opposite side of the first obstacle OB1 #, a risk area is not set.

As described above, since the automated driving control device 100 does not set a risk area when the recognizer 130 can recognize the object on the opposite side of the first obstacle OB1 #, it is possible to suppress excessive deceleration of the vehicle M.

FIG. 13 is a diagram (part 2) which shows an example of a situation in which a risk area is not set. When conditions of (1) there is the first obstacle OB1 that makes it difficult to recognize a situation on an opposite side in the recognition of a situation executed by the recognizer 130 in the extending direction of a road, (2) an end of the first obstacle OB1 is recognized and the first obstacle OB1 extends a first predetermined distance forward from the end, but (3) there is no second obstacle that makes it difficult to recognize the situation on the opposite side over a second predetermined distance or more on a traveling direction side of the mobile object from the end are not satisfied, the setting processor 142 does not set a risk area at a reference position based on the end of the first obstacle OB1. For example, when a length between the end of the first obstacle OB1 and an obstacle OB2 # in the X direction is a length less than a second predetermined distance, a risk area is not set.

As described above, since the automated driving control device 100 does not set a risk area when there is an interval between the first obstacle OB1 and the second obstacle OB2 #, but a length of the interval in the X direction is less than the second predetermined distance, it is possible to suppress excessive deceleration of the vehicle M.

[Flowchart]

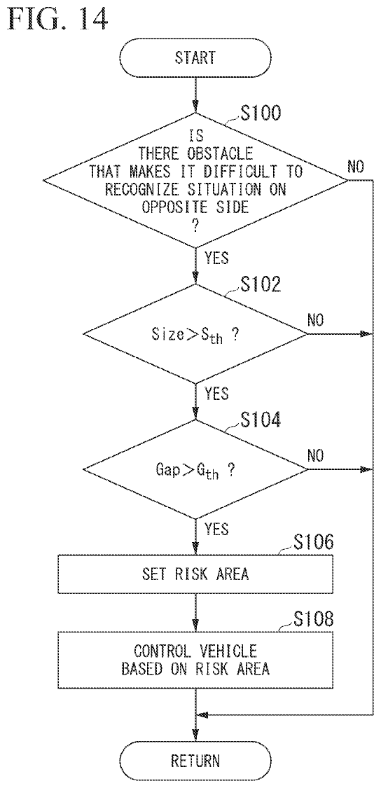

FIG. 14 is a flowchart which shows an example of a flow of processing executed by the automated driving control device 100. First, the automated driving control device 100 determines whether there is a first obstacle that makes it difficult to recognize a situation on an opposite side in the recognition of the situation executed by the recognizer 130 in the extending direction of a road (step S100). When there is a first obstacle that makes it difficult to recognize the situation on the opposite side, the automated driving control device 100 determines whether the end of the first obstacle is recognized and the first obstacle extends a first predetermined distance forward from the end (Size>Sₜₕ?) (step S102).

When the first obstacle extends from the end to the front side by the first predetermined distance, the automated driving control device 100 determines whether there is no second obstacle that makes it difficult to recognize the situation on the opposite side over a second predetermined distance or more on a traveling direction side of a vehicle from the end of the first obstacle (Gap>Gₜₕ?) (step S104). When there is no second obstacle that makes it difficult to recognize the situation on the opposite side over the second predetermined distance on the traveling direction side of the vehicle from the end of the first obstacle, the setting processor 142 sets a risk area at a reference position based on the end of the first obstacle (step S106). Next, the automated driving control device 100 controls at least the speed of a mobile object based on the risk area (step S108). As a result, processing of one routine of this flowchart ends. When the determinations of steps S100, S102, and S104 described above are negative, the processing of one routine of this flowchart ends. Some of the processing described above may be omitted.

According to the embodiment described above, when (1) there is a first obstacle that makes it difficult to recognize a situation on an opposite side in the recognition of a situation by the recognizer in the extending direction of a road, (2) an end of the first obstacle is recognized and the first obstacle extends a first predetermined distance forward from the end, and (3) there is no second obstacle that makes it difficult to recognize the situation on the opposite side over a second predetermined distance or more on a traveling direction side of the mobile object from the end, the automated driving control device 100 sets a risk area at a reference position based on the end of the first obstacle, and control at least the speed of the mobile object based on the set risk area, thereby controlling the mobile object more appropriately.

In the present embodiment, it has been described that a function of the setting processor 142 is mounted in a vehicle that performs automated driving, but, the function of the setting processor 142 may also be mounted in, for example, a vehicle that automatically controls a degree of deceleration. For example, in this vehicle, the driver controls the setting processor 142 controls the degree of deceleration. The function of the setting processor 142 may be mounted in a device different from a vehicle, and the vehicle M may control the degree of deceleration based on information on a risk area acquired from a different device.

Although a mode for carrying out the present invention has been described above using the embodiment, the present invention is not limited to the embodiment, and various modifications and substitutions can be made within a range not departing from the gist of the present invention.

What is claimed is:

1. A control device for a mobile object comprising:
a storage device that has stored a program; and
a hardware processor,
wherein the hardware processor executes the program stored in the storage device, thereby
recognizing a situation in a periphery of a mobile object,
executing control processing of controlling acceleration or deceleration of the mobile object based on the recognized situation in the periphery of the mobile object, and,
in the control processing,
when (1) there is a first obstacle that makes it difficult to recognize a situation on an opposite side in recognition of the situation in an extending direction of a road,
(2) an end of the first obstacle is recognized and the first obstacle extends a first predetermined distance forward from the end, and
(3) there is no second obstacle that makes it difficult to recognize the situation on the opposite side over a second predetermined distance on a traveling direction side of the mobile object from the end,
setting a risk area at a reference position based on the end of the first obstacle, and controlling at least a speed of the mobile object based on the set risk area.

2. The control device for a mobile object according to claim 1,
wherein the hardware processor causes the mobile object to decelerate as the mobile object approaches the risk area.

3. The control device for a mobile object according to claim 1,
wherein the hardware processor increases a size of the set risk area as the mobile object approaches the end of the first obstacle.

4. The control device for a mobile object according to claim 1,
wherein the hardware processor increases a size of the set risk area as the mobile object approaches the end of the first obstacle, and causes the mobile object to decelerate as the mobile object approaches the risk area.

5. The control device for a mobile object according to claim 1,
wherein the hardware processor determines a size of the risk area based on a recommended speed on a road on which the mobile object is present.

6. The control device for a mobile object according to claim 1,
wherein the first predetermined distance is a sufficient length for a person to hide on an opposite side of the first obstacle.

7. The control device for a mobile object according to claim 1,
wherein the second predetermined distance is a sufficient length for a person to pass therethrough.

8. The control device for a mobile object according to claim 1,
wherein the hardware processor causes the mobile object to decelerate to a first speed when (1), (2), and (3) are satisfied, and
controls the mobile object to travel at a speed higher than the first speed without causing the mobile object to decelerate to the first speed when (1), (2), and (3) are satisfied, and there is furthermore a second lane between the first obstacle and a first lane in which the mobile object moves.

9. A control method for a mobile object comprising:
by a computer,
recognizing a situation in a periphery of a mobile object;
controlling acceleration or deceleration of the mobile object based on a recognized situation in the periphery; and,
when (1) there is a first obstacle that makes it difficult to recognize a situation on an opposite side in recognition of the situation in an extending direction of a road,
(2) an end of the first obstacle is recognized and the first obstacle extends a first predetermined distance forward from the end, and
(3) there is no second obstacle that makes it difficult to recognize the situation on the opposite side over a second predetermined distance on a traveling direction side of the mobile object from the end,
setting a risk area at a reference position based on the end of the first obstacle, and controlling at least a speed of the mobile object based on the set risk area.

10. A computer-readable non-transitory storage medium that has stored a program causing a computer to execute:
recognizing a situation in a periphery of a mobile object,
controlling acceleration or deceleration of the mobile object based on a recognized situation in the periphery; and,
when (1) there is a first obstacle that makes it difficult to recognize a situation on an opposite side in recognition of the situation in an extending direction of a road,
(2) an end of the first obstacle is recognized and the first obstacle extends a first predetermined distance forward from the end, and
(3) there is no second obstacle that makes it difficult to recognize the situation on the opposite side over a second predetermined distance on a traveling direction side of the mobile object from the end,
setting a risk area at a reference position based on the end of the first obstacle, and controlling at least a speed of the mobile object based on the set risk area.
